(19) United States
(12) Patent Application Publication
(10) Pub. No.: US 2012/0012260 A1
(43) Pub. Date: Jan. 19, 2012

(54) RETRACTABLE SHADE ASSEMBLY WITH ADJUSTABLE SIDE GUIDES

(76) Inventors: Leonard Elinson, Manhattan Beach, CA (US); Richard R. Fraczek, Valencia, CA (US)

(21) Appl. No.: 12/838,105

(22) Filed: Jul. 16, 2010

(51) Int. Cl. E06B 9/44; B23P 11/00; E06B 9/24

(52) U.S. Cl. 160/240; 160/375; 29/428

(57) ABSTRACT

An adjustable side channel assembly for use with screens and shades includes a pair of adjustable side guides, each laterally adjustable with respect to a corresponding side frame. Each side guide may be moved to a desired position and then secured to the side frame with a fastener. Each side guide includes an axial fabric retainer configured to receive a side gimp of a shade. Each fabric retainer is loosely retained in a hollow channel within the side guide and laterally movable to enable both sides of a shade to lie substantially parallel when the shade is drawn. A take-up mechanism includes dual rollers with the outer roller having a shorter width to provide space for the side gimps to roll up and not spiral out when the shade is taken up.

### FIELD OF THE INVENTION

The present invention relates to a shade or screen assembly for fenestrations, including windows and skylights.

### BACKGROUND OF THE INVENTION

### Description of Prior Art and Related Information

Screen shades are used as window treatments for both windows and skylights. In conventional screen setup, a pair of fixed side guides are secured to the window jambs to provide channels for receiving both sides of a screen shade. The pair of jambs for a typical window, however, is often not perfectly parallel. Therefore, securing fixed side channels to non-parallel jambs leads to non-parallel, fixed side guides. Accordingly, additional time, labor and expense is spent at the assembly stage in attempting to make both fixed side guides parallel prior to securing to the jambs. Otherwise, shades will crimp, wrinkle, fold or appear other than flat when drawn on a setup with non-parallel side guides.

Furthermore, a conventional shade may include a pair of side gimps received in the side channels. When the shade is rolled up, the extra bulk caused by the rolling up of the side gimps will cause the sides of the shade to spiral sideways, a generally undesirable and unsightly consequence.

In the past, assembly of the motorized skylight consisted of the side channels hiding the sides of the shade rolled up on the tube on one side of the skylight opening. Cables were typically stretched from that shade to the other end of the opening and wounded up on another tube with the aid of the motor, or clutch or torsion spring. The side channels could be constructed as simple L-channel with the longer side protruding from the wall and shorter used to secure the side channel to the wall with the screws. In this configuration skylight shade fabric would simply rest on the top the extrusion while fully deployed. Side channel could also be made in U-shape to better guide the shade and provide better closure from the light coming from above. The U-shape channel could be made as one piece or two piece assembly snapped together during installation.

Biggest problem with that type of skylight construction is a size limitation. Typically skylights wider than 60 inches couldn't be made to operate properly. Gravity pulls the fabric down when the shade is installed horizontally causing it to sag in the center. The sagging pulls the sides of the shade towards the center and at some point the sides will slide out of the side channels exposing the edges and allowing the light to come through.

Variety of fixes were invented over the years aimed at fixing this problem and allowing for bigger and bigger shades to be made. Most common fix is to install the cables across the skylight opening and allow the shade to rest on those cables while fully deployed. This solution leaves cables visible and obstructing the view while the shade is retracted. Dragging the shades over the cables soils the fabric and wears them out on contact points. Yet another solution is to imbed rods or strips of stiff material into the shade normally across the width of the shade to stiffen the shade itself and prevent it from sagging. For that solution fix pockets are made across the shade either by sowing additional material or heat sealing it to the shade. While this solution works to certain degree, it creates much bigger rollup diameter which requires further increasing size of the enclosure housing the shade. This solution also deforms the shade material during rolling on the tube which further takes away from the appeal of the skylight.

### SUMMARY OF THE INVENTION

The present invention provides structures and methods which overcome the deficiencies in the prior art.

In one aspect, a shade assembly is provided. The assembly comprises a pair of fixed side frames and a pair of adjustable side guides. Each adjustable side guide is initially laterally adjustable with respect to a corresponding side frame and configured to be fixed to each corresponding side frame in a desired position, each adjustable side guide comprising an axial fabric retainer. The assembly may further comprise a pair of securing mechanisms for fixing each adjustable side guide to the corresponding fixed side frame at a desired position.

The assembly may further comprise a shade including a pair of side gimps. Each side gimp is received in a corresponding fabric retainer.

Each adjustable side guide defines a hollow space. Each fabric retainer is loosely movable in the hollow space so as to enable the shade to be drawn straightly while both side gimps remain substantially parallel.

The assembly may further comprise a take-up mechanism configured to retain the shade. The take-up mechanism comprises an axle, an inner roller coupled to the axle, the inner roller having a first diameter and a first width; and an outer roller concentric with respect to the inner roller. The outer roller has a second width less than the first width, and a second diameter greater than the first diameter.

Each side frame preferably comprises an axial frame flange. Each adjustable side guide comprises an axial flange substantially parallel to a corresponding frame flange. Each securing mechanism comprises a screw configured to be screwed through the axial flange and the corresponding frame flange. Each adjustable side guide is laterally adjustable with respect to each side frame in a preferred range of 0.1 inch to 1.6 inches.

The pair of adjustable side guides may be oriented horizontally and configured to direct a shade in a side-to-side direction. The pair of adjustable side guides may also be slanted and substantially parallel to each other.

In another aspect, a shade assembly is provided for use in connection with a fenestration having a pair of jambs. The assembly comprises a pair of adjustable side guides. Each adjustable side guide is disposed adjacent to a corresponding jamb and is laterally adjustable with respect to the corresponding jamb prior to being fixed in position. Each adjustable side guide comprises an axial fabric retainer. The assembly comprises a shade having a pair of side gimps. Each side gimp is received in a corresponding fabric retainer.

Each adjustable side guide defines a hollow space. Each fabric retainer is loosely movable in the hollow space so as to enable the shade to be drawn straightly while both side gimps remain substantially parallel.

Each adjustable side guide is laterally adjustable with respect to the corresponding jamb in a preferred range of 0.1 inch to 1.6 inches.

The assembly further comprises a pair of fixed side frames coupled to the pair of adjustable side guides and the corresponding pair of jambs.

The assembly further comprises a pair of securing mechanisms for fixing each adjustable side guide to the corresponding fixed side frame at a desired position.

Each side frame comprises an axial frame flange. Each adjustable side guide comprises an axial flange substantially parallel to a corresponding frame flange. Each securing mechanism comprises a screw configured to be screwed through the axial flange and the corresponding frame flange.

The assembly further comprises a take-up mechanism configured to retain the shade. The take-up mechanism comprises an axle, an inner roller coupled to the axle, the inner roller having a first diameter and a first width, and an outer roller concentric with respect to the inner roller, the outer roller having a second width less than the first width, and a second diameter greater than the first diameter.

The pair of adjustable side guides may be oriented horizontally and configured to direct the shade in a side-to-side direction. The pair of adjustable side guides may also be slanted and substantially parallel to each other.

In a further aspect, a shade assembly comprises a pair of fixed side frames and a pair of adjustable side guides. Each adjustable side guide is laterally adjustable with respect to a corresponding side frame. Each adjustable side guide is configured to be fixed to the corresponding side frame after adjusted to a desired position, each adjustable side guide comprising an axial fabric retainer. The assembly comprises a shade defining a shade width and including a pair of side gimps. Each side gimp is received in a corresponding fabric retainer. The assembly also comprises a take-up mechanism having an axle and an outer roller having an outer roller width less than the shade width.

The take-up mechanism further comprises an inner roller coupled to the axle and concentrically disposed within the outer roller. The inner roller has an inner roller width that is greater than the outer roller width. The assembly further comprises a pair of securing mechanisms for fixing each adjustable side guide to the corresponding side frame at the desired position.

Each adjustable side guide defines a hollow space. Each fabric retainer is loosely movable in the hollow space so as to enable the shade to be drawn straightly while both side gimps remain substantially parallel. Each adjustable side guide is laterally adjustable with respect to the corresponding jamb in a range of 0.1 inch to 1.6 inches.

Each side frame preferably comprises an axial frame flange. Each adjustable side guide preferably comprises an axial flange substantially parallel to a corresponding frame flange. Each securing mechanism preferably comprises a screw configured to be screwed through the axial flange and the corresponding frame flange.

In a further aspect, a method is provided for assembling a shade assembly. The method comprises laterally adjusting a first side guide with respect to a first side frame to a first desired position, securing the first side guide to the first side frame in the desired position, laterally adjusting a second side guide with respect to a second side frame to a second desired position, securing the second side guide to the second side frame in the desired position, inserting a first side gimp of a shade into a first fabric retainer in the first side guide, and inserting a second side gimp of the shade into a second fabric retainer in the second side guide.

The step of laterally adjusting the first side guide with respect to the first side frame comprises adjusting the first side guide laterally between 0.1 inch to 1.6 inches with respect to the first side frame. The step of laterally adjusting the second side guide with respect to the second side frame comprises adjusting the second side guide laterally between 0.1 inch to 1.6 inches with respect to the second side frame.

The step of inserting the first side gimp of the shade into the first fabric retainer comprises providing a first hollow space in the first fabric retainer for loose lateral movement of the first side gimp when the shade is drawn.

The step of inserting the second side gimp of the shade into the second fabric retainer comprises providing a second hollow space in the second fabric retainer for loose lateral movement of the second side gimp when the shade is drawn.

The method further comprises rolling the shade with a take-up mechanism, providing a first void at a first side portion of the take-up mechanism to accommodate the first side gimp being rolled up, and providing a second void at a second side portion of the take-up mechanism to accommodate the second side gimp being rolled up.

### BRIEF DESCRIPTION OF THE DRAWINGS

FIG. 1 is a perspective view of a preferred embodiment of a shade assembly with an adjustable side guide;

FIG. 2 is a perspective view of a preferred embodiment of a take-up mechanism;

FIG. 3 is a perspective view of the preferred embodiment of the shade assembly;

FIG. 4 is a front elevation view of the preferred embodiment of the shade assembly;

FIG. 5 is a diagram of a preferred method for assembling a shade assembly;

FIG. 6 is a cutaway view of a motor system;

FIG. 7 is a perspective view of a second preferred embodiment of a shade assembly; and

FIG. 8 is a front elevation view of a third preferred embodiment of a shade assembly.

### DETAILED DESCRIPTION OF THE PREFERRED EMBODIMENTS

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

Throughout the specification, positional and directional terms below refer to the following:
axial or vertical generally refer to the direction in which the shade is drawn or taken up;
lateral, sideways or horizontal refer to a direction generally perpendicular to the direction in which the shade is drawn or taken up;
Back, rear, front, outward, inward or interior refer to the perspective of a user located within the building in which the assembly is placed and facing the assembly.

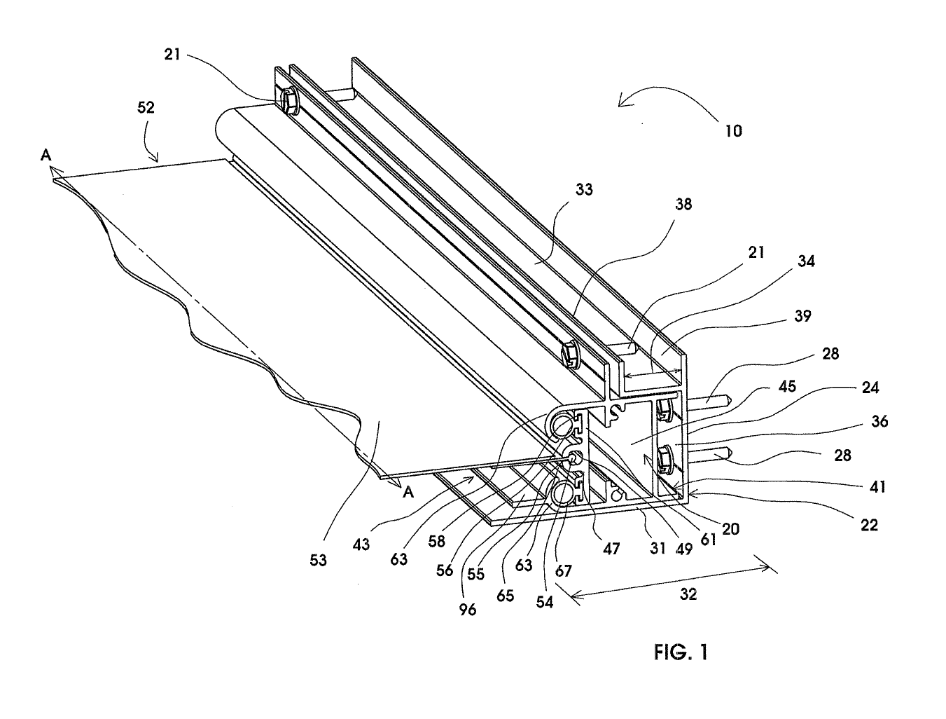

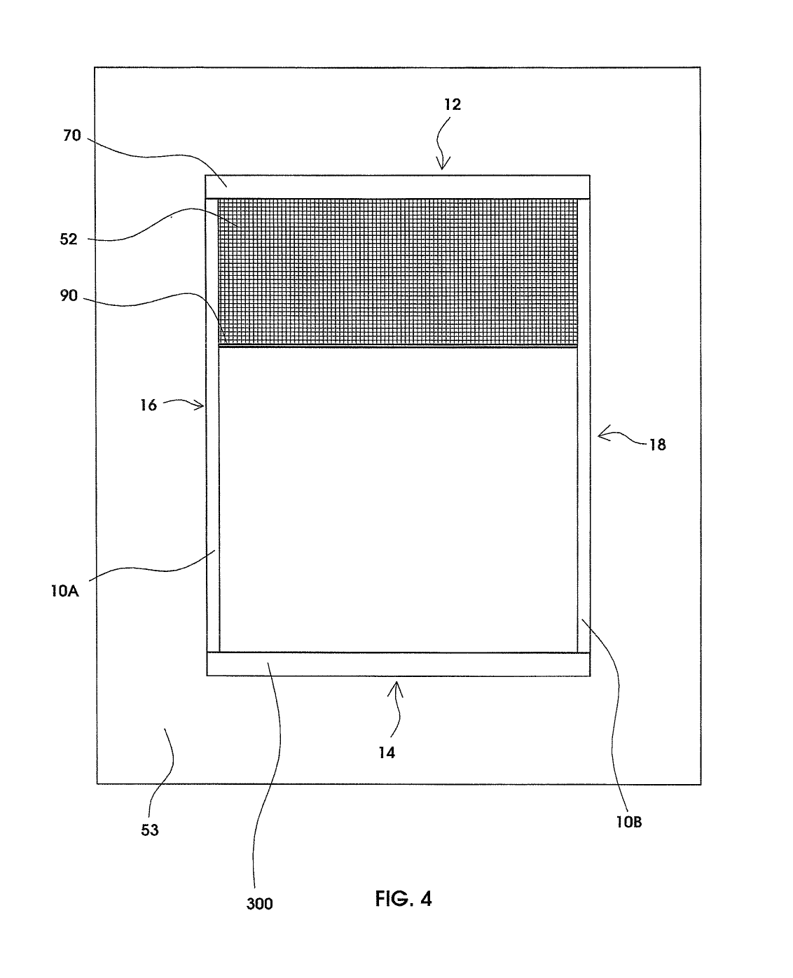

In FIG. 1, a first preferred embodiment of a side channel assembly, or simply shade assembly, is configured for use in connection with retractable shades or screens, and is designated generally by the reference numeral 10. The preferred assembly 10 is configured to be used with any fenestration, such as windows and skylights, in any orientation (e.g., vertical, horizontal, etc.). The assembly 10 defines an axis “A” generally parallel to the direction in which a shade is drawn. The assembly 10 also includes a head portion 12, a tail portion 14, a left side 16 and a substantially symmetrical right side 18, as best shown in FIG. 4.

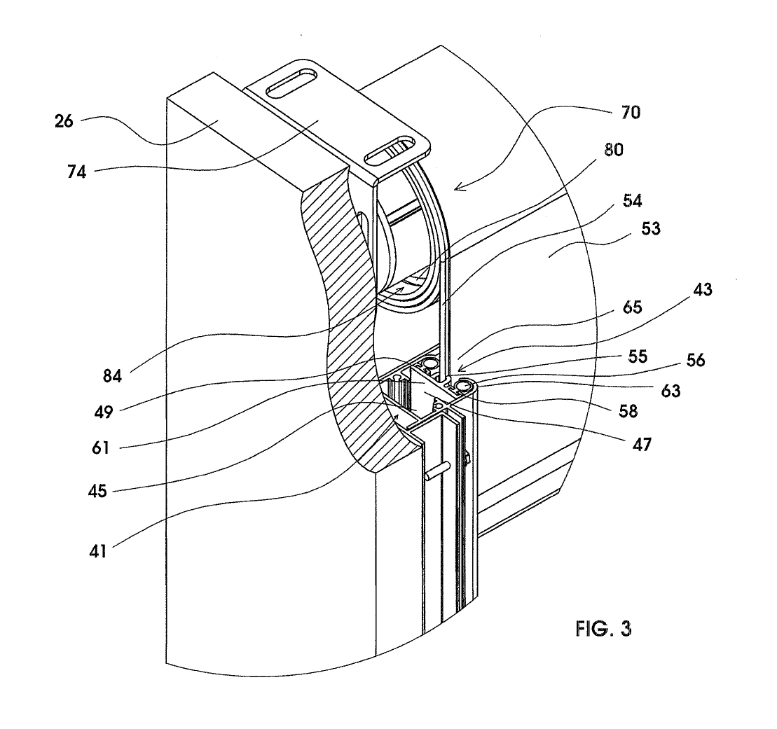

The assembly 10 comprises a pair of adjustable side guides, or adjustable side channels, 20 and a corresponding pair of fixed side frames 22. Each of the left and right adjustable side guides 20 is laterally adjustable with respect to the corresponding fixed side frame 22. Each fixed side frame 22 comprises an inwardly protruding lateral wall 24 configured to abut a jamb or other building structure surrounding the fenestration to be treated. One or more fasteners 28, such as screws, can be used to secure the fixed side frame 22 to the jamb 26, as shown in FIG. 3.

Each side frame 22 comprises a back extension wall 31 with a first length 32 and a front extension wall 33 with a second length 34, both extending medially from, and generally perpendicularly to, the lateral wall 24. These two extension walls 31, 33 define a space 36 for accommodating the adjustable side guide 20 and provide a length of extension, or a range of lateral movement, by which the side guide 20 may be adjusted laterally. Each side frame 22 preferably comprise an anchor 38 onto which the corresponding adjustable side guide 20 is secured after the side guide 20 is adjusted to the desired position and configuration. In the first preferred embodiment, the frame anchor 38 comprises an axial frame flange 38 that is inwardly protruding and preferably located at a medial end of the front extension wall 33. A second, lateral axial flange 39 is configured to abut a window jamb.

Each adjustable side guide 20 is laterally adjustable, or movable sideways, with respect to the corresponding fixed frame 22. Thus, each side guide 20 is also laterally adjustable with respect to the corresponding jamb onto which the frame 22 is secured. In the preferred embodiment, each adjustable side guide 20 is laterally movable with respect to the frame 22 in the range of 0.1 inch to 1.6 inches. The side guide 20 preferably comprises a lateral portion 41 and a medial portion 43, and defines a hollow space 45 therebetween.

In FIGS. 1 and 3, a fabric retainer 47 is loosely disposed in the hollow space 45 and configured to be loosely movable between the lateral portion 41 and the medial portion 43 of the side guide 20. Alternatively stated, the fabric retainer 47 is laterally movable in the hollow space 45 in a loose and free manner. The fabric retainer 47 comprises an axial retainer channel 49 configured to receive a side edge of a shade 52. In the preferred embodiment, the shade 52 comprises a fabric 53 and a pair of enlarged or thickened side edges, or gimps, 54 which may be sewed onto or heat sealed to the fabric 53. In the first preferred embodiment, the retainer channel 49 is sized and shaped to receive a side gimp 54 of the shade 52 and to prevent the gimp 54 from escaping out in a medial direction. A medial slot 55 is formed in the fabric retainer 47 and in communication with the retainer channel 49. The slot 55 is sufficiently sized to enable the fabric of the shade 52 to traverse, but narrow so as to prevent the gimp 54 retained in the channel 49 from escaping medially and coming loose (e.g., slot size is smaller than diameter of gimp 54).

Each fabric retainer 47 may comprise one or more medial cushions 56 configured to cushion the retainer 47 when the retainer 47 is tensioned in a medial direction by the shade 52. In the preferred embodiment, each side comprises a pair of axial bulb cushions 56 retained in grooves 58 formed in a retainer base 61. In the preferred embodiment, the medial portion 43 of each side guide 20 comprises a pair of curved walls 63 configured to conform to the corresponding pair of bulb cushions 56, with a gap 65 between the walls 63 accommodating the shade 52. Each bulb cushion 56 is preferably hollow so as to retain air, thereby providing excellent dampening characteristics. Both open ends 67 of each bulb cushion may be sealed to prevent air from escaping.

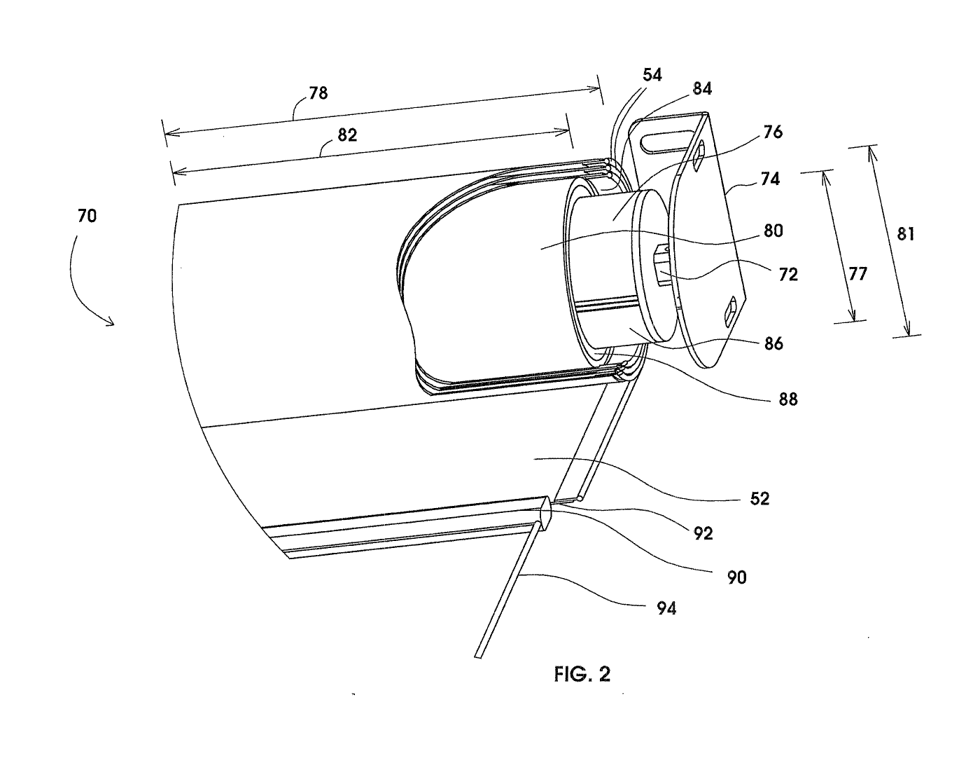

In FIGS. 2 and 3, the preferred assembly 10 comprises a preferred take-up mechanism 70 preferably configured to retain shades having thickened side edges, such as the preferred shade 52 disclosed above having side gimps 54. The take-up mechanism 70 houses a shade when retracted and facilitates the drawing and retracting of the shade.

In the preferred embodiment, the take-up mechanism 70 comprises an axle 72 coupled to a pair of side brackets 74 and inserted through a first inner roller 76. The first inner roller 76 comprises a first outer diameter 77 and a first width 78, best shown in FIG. 2. The take-up mechanism 70 further comprises a second outer roller 80 concentric to the inner roller 76. The second outer roller 80 has a second outer diameter 81 that is larger than the first outer diameter 77 and a second width 82 that is lesser than the first width 78 so as to create a pair of lateral voids, or gaps, 84 that are specially configured to accommodate the rolling up of the side gimps 54 at both sides of the shade 52 so as to prevent lateral spiraling associated with prior art take-up mechanisms. Alternatively stated, the void 84 comprises the annular space surrounding the exposed side portions 86 of the inner roller 76, namely, exposed by the lesser width 82 of the outer roller 80. The second outer roller 80 is centrally located with respect to the inner roller 76 so as to create gaps 84 of substantially equal width and size. An annular tube spacer 88 having a width equal to or less than the outer roller width 83 may be disposed between the inner roller 76 and the outer roller 80.

When the shade 52 is retracted and thus rolled on the take-up mechanism 70, the pair of gaps 84 enable the side gimps 54 to roll up without spiraling laterally. In particular, the gap 54 enables the inner rolls of the gimps 54 to be pressed down and collapsed, allowing for even wraps to be formed on the take-up mechanism 70.

In FIG. 2, a hem bar 90 is attached to an exposed end 92 of the shade 52. One or more cables 94 are attached to the hem bar 90 to facilitate pulling of the bar 90 and thus, the shade 52. An opposite end of the cable 94 may be manually accessible or wound on a motorized tube to facilitate pulling. As shown in FIG. 1, each adjustable side guide 20 may comprise a shelf 96 to support the axial travel of the hem bar 90.

In a second preferred embodiment illustrated in FIG. 4, the take-up mechanism 70b may omit the inner roller, shown as 70 in the first preferred take-up mechanism, entirely so as to create a void 84b.

FIG. 3 illustrates the system 10 including the take-up mechanism 70 and the adjustable side guides 20.

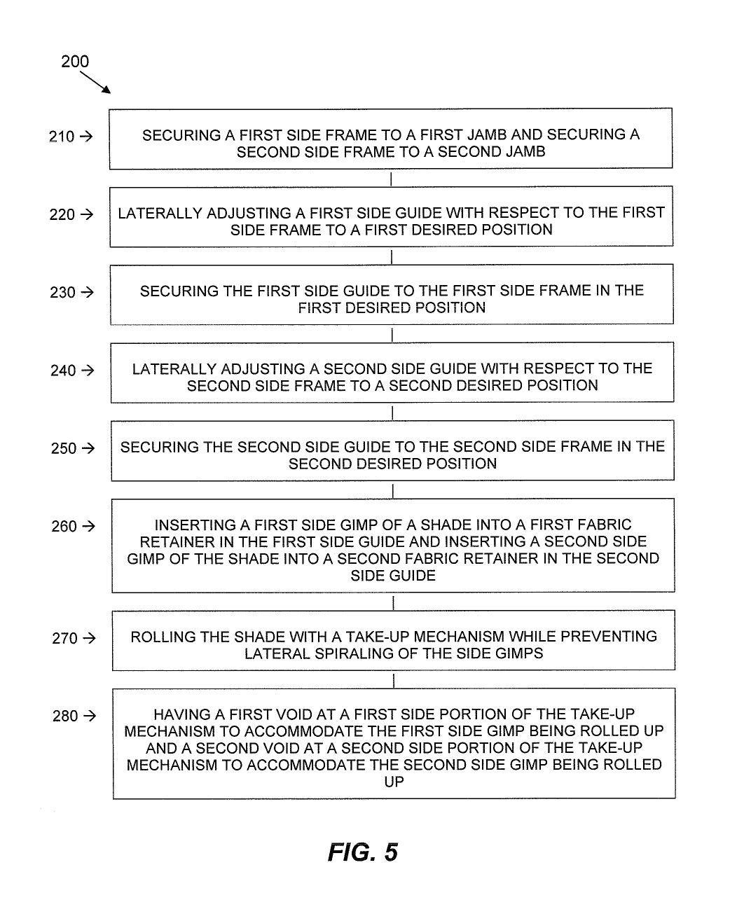

FIG. 5 illustrates a preferred method 200 for assembling a shade assembly. The method 200 comprises the step 210 of securing a first side frame to a first jamb and securing a second side frame to a second jamb. Step 220 comprises laterally adjusting a first adjustable side guide with respect to the first side frame to a first desired position. After the first side guide is laterally adjusted to the desired position, step 230 comprises securing the first side guide to the first side frame in the first desired position.

Step 240 comprises laterally adjusting a second adjustable side guide with respect to the second side frame to a second desired position. After the second side guide is laterally adjusted to the second desired position, step 250 comprises securing the second side guide to the second side frame in the second desired position.

Thus, in the preferred method 200, each side guide is initially adjusted with respect to its corresponding side frame in steps 220 and 240 prior to the securing the side guide to the corresponding side frame in steps 230 and 250.

Step 260 comprises inserting the first side gimp of a shade into a first fabric retainer in the first side guide, and inserting a second side gimp of the shade into a second fabric retainer in the second side guide. Step 270 comprises rolling or taking up with shade with a take-up mechanism while preventing lateral spiraling of the side gimps. Accordingly, step 270 may comprise providing a take-up mechanism having a first void at a first side portion of the take-up mechanism to accommodate the first side gimp being rolled up, and a second void at a second side portion of the take-up mechanism to accommodate the second side gimp being rolled up.

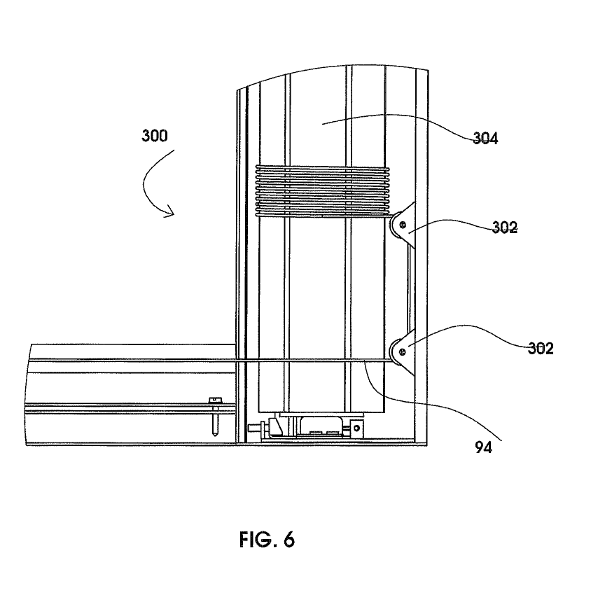

FIG. 6 illustrates a tensioning system 300 which opens or retracts the shade in the above embodiments. In particular, the tension cord, or cable, 94 is routed through cable pulleys 302 and wound on a motor tube 304.

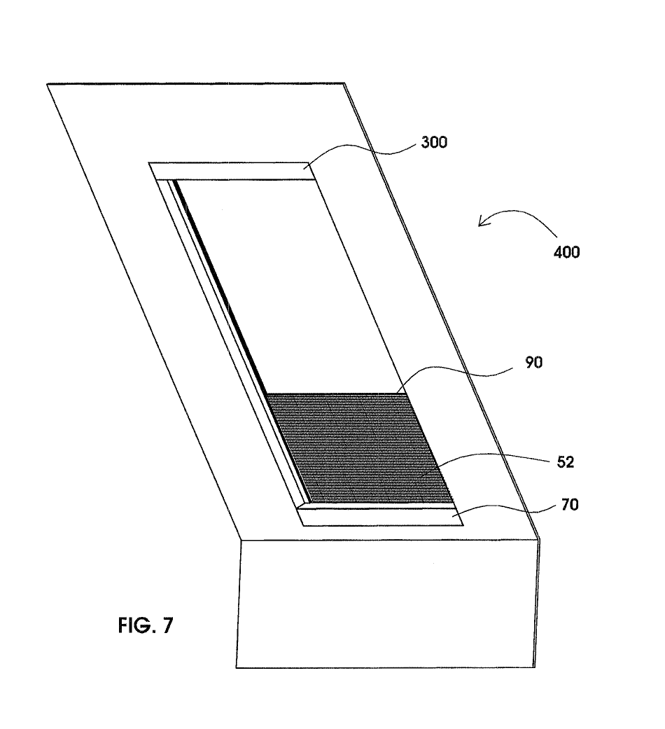

FIG. 7 illustrates a second preferred embodiment of a shade assembly 400 having a slanted configuration.

The preferred take up mechanism 70 is situated at the bottom with an L-shape fascia covering it from the front. The preferred tensioning system 300 is disposed at the top with two adjustable side channel assemblies, as discussed above in connection with FIGS. 1 and 3, disposed on either side of the fabric 52. In this configuration the shade rises and lowers parallel to the window at the angle the window opening is constructed. The shade could operate at any angle from 0° horizontal to 90° (vertical).

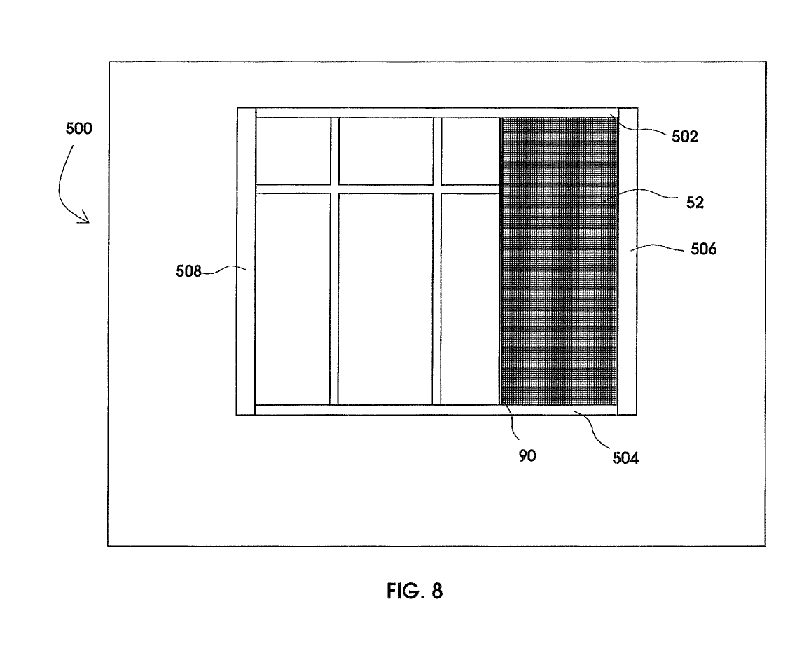

FIG. 8 illustrates how the first preferred embodiment of a shade assembly 10, as discussed above in connection with FIGS. 1-3, may be employed in a sideways orientation wherein the shade 52 is configured to open and close horizontally. In FIG. 8, the shade assembly 10 comprises a pair of adjustable side guides 20 which are disposed at the top 502 and bottom 504 of the window structure 510. The take-up mechanism 70 and tensioning system 520 are disposed on opposites sides of the window structure 510, shown in the illustrated embodiment as the right side 506 and left side 508, respectively.

In a side to side operation, the preferred shade assembly 10 offers several advantages over conventional vertical blinds and draperies. In particular, the bottoms of conventional vertical blinds and draperies are hung loosely and, are thus, susceptible to movement, e.g., as a result of wind, which can be unsightly. In the case of conventional rigid structures such as blinds, such free movement can be undesirably noisy when the blinds bang against adjacent structures as a result of a draft. With the preferred shade assembly 10, the shade 52 can be securely deployed without leaving any loose or freely floating parts.

Furthermore, the take-up mechanism 70 occupies minimal space and can reside within a side enclosure 522 so as to hide the shade fabric 52 when completely retracted.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

1. A shade assembly, comprising:
a pair of fixed side frames; and
a pair of adjustable side guides, each adjustable side guide being initially laterally adjustable with respect to a corresponding side frame and configured to be fixed to each corresponding side frame in a desired position, each adjustable side guide comprising an axial fabric retainer.

2. The assembly of claim 1, further comprising a pair of securing mechanisms for fixing each adjustable side guide to the corresponding fixed side frame at a desired position.

3. The assembly of claim 1, further comprising a shade including a pair of side gimps, each side gimp received in a corresponding fabric retainer.

4. The assembly of claim 3, wherein:
each adjustable side guide defines a hollow space; and
each fabric retainer is loosely movable in the hollow space so as to enable the shade to be drawn straightly while both side gimps remain substantially parallel.

5. The assembly of claim 3, further comprising a take-up mechanism configured to retain the shade, the take-up mechanism comprising:
an axle;
an inner roller coupled to the axle, the inner roller having a first diameter and a first width; and
an outer roller concentric with respect to the inner roller, the outer roller having a second width less than the first width, and a second diameter greater than the first diameter.

6. The assembly of claim 1, wherein:
each side frame comprises an axial frame flange;
each adjustable side guide comprises an axial flange substantially parallel to a corresponding frame flange; and
each securing mechanism comprises a screw configured to be screwed through the axial flange and the corresponding frame flange.

7. The assembly of claim 1, wherein each adjustable side guide is laterally adjustable with respect to each side frame in a range of 0.1 inch to 1.6 inches.

8. The assembly of claim 1, wherein the pair of adjustable side guides are oriented horizontally and configured to direct a shade in a side-to-side direction.

9. The assembly of claim 1, wherein the pair of adjustable side guides are slanted and substantially parallel to each other.

10. A shade assembly for use in connection with a fenestration having a pair of jambs, comprising:
a pair of adjustable side guides, each adjustable side guide being disposed adjacent to a corresponding jamb and being laterally adjustable with respect to the corresponding jamb prior to being fixed in position, each adjustable side guide comprising an axial fabric retainer; and
a shade including a pair of side gimps, each side gimp received in a corresponding fabric retainer.

11. The assembly of claim 10, wherein:
each adjustable side guide defines a hollow space; and
each fabric retainer is loosely movable in the hollow space so as to enable the shade to be drawn straightly while both side gimps remain substantially parallel.

12. The assembly of claim 10, wherein each adjustable side guide is laterally adjustable with respect to the corresponding jamb in a range of 0.1 inch to 1.6 inches.

13. The assembly of claim 10, further comprising a pair of fixed side frames coupled to the pair of adjustable side guides and the corresponding pair of jambs.

14. The assembly of claim 13, further comprising a pair of securing mechanisms for fixing each adjustable side guide to the corresponding fixed side frame at a desired position.

15. The assembly of claim 14, wherein:
each side frame comprises an axial frame flange;
each adjustable side guide comprises an axial flange substantially parallel to a corresponding frame flange; and
each securing mechanism comprises a screw configured to be screwed through the axial flange and the corresponding frame flange.

16. The assembly of claim 10, further comprising a take-up mechanism configured to retain the shade, the take-up mechanism comprising:
an axle;
an inner roller coupled to the axle, the inner roller having a first diameter and a first width; and
an outer roller concentric with respect to the inner roller, the outer roller having a second width less than the first width, and a second diameter greater than the first diameter.

17. The assembly of claim 10, wherein the pair of adjustable side guides are oriented horizontally and configured to direct the shade in a side-to-side direction.

18. The assembly of claim 10, wherein the pair of adjustable side guides are slanted and substantially parallel to each other.

19. A shade assembly, comprising:
a pair of fixed side frames;
a pair of adjustable side guides, each adjustable side guide being laterally adjustable with respect to a corresponding side frame, each adjustable side guide being configured to be fixed to the corresponding side frame after adjusted to a desired position, each adjustable side guide comprising an axial fabric retainer;
a shade defining a shade width and including a pair of side gimps, each side gimp received in a corresponding fabric retainer; and
a take-up mechanism comprising an axle and an outer roller having an outer roller width less than the shade width.

20. The assembly of claim 19, wherein the take-up mechanism further comprises an inner roller coupled to the axle and concentrically disposed within the outer roller, the inner roller having an inner roller width that is greater than the outer roller width.

21. The assembly of claim 19, further comprising a pair of securing mechanisms for fixing each adjustable side guide to the corresponding side frame at the desired position.

22. The assembly of claim 19, wherein:
each adjustable side guide defines a hollow space; and
each fabric retainer is loosely movable in the hollow space so as to enable the shade to be drawn straightly while both side gimps remain substantially parallel.

23. The assembly of claim 19, wherein each adjustable side guide is laterally adjustable with respect to the corresponding jamb in a range of 0.1 inch to 1.6 inches.

24. The assembly of claim 19, wherein:
each side frame comprises an axial frame flange;
each adjustable side guide comprises an axial flange substantially parallel to a corresponding frame flange; and
each securing mechanism comprises a screw configured to be screwed through the axial flange and the corresponding frame flange.

25. A method for assembling a shade assembly, comprising:
laterally adjusting a first side guide with respect to a first side frame to a first desired position;
securing the first side guide to the first side frame in the desired position;
laterally adjusting a second side guide with respect to a second side frame to a second desired position;
securing the second side guide to the second side frame in the desired position;
inserting a first side gimp of a shade into a first fabric retainer in the first side guide; and
inserting a second side gimp of the shade into a second fabric retainer in the second side guide.

26. The method of claim 25, wherein:
the step of laterally adjusting the first side guide with respect to the first side frame comprises adjusting the first side guide laterally between 0.1 inch to 1.6 inches with respect to the first side frame; and
the step of laterally adjusting the second side guide with respect to the second side frame comprises adjusting the second side guide laterally between 0.1 inch to 1.6 inches with respect to the second side frame.

27. The method of claim 25, wherein:
the step of inserting the first side gimp of the shade into the first fabric retainer comprises providing a first hollow space in the first fabric retainer for loose lateral movement of the first side gimp when the shade is drawn; and
the step of inserting the second side gimp of the shade into the second fabric retainer comprises providing a second hollow space in the second fabric retainer for loose lateral movement of the second side gimp when the shade is drawn.

28. The method of claim 25, further comprising:
rolling the shade with a take-up mechanism;
providing a first void at a first side portion of the take-up mechanism to accommodate the first side gimp being rolled up; and
providing a second void at a second side portion of the take-up mechanism to accommodate the second side gimp being rolled up.
